(19) United States
(12) Patent Application Publication
(10) Pub. No.: US 2018/0150773 A1
(43) Pub. Date: May 31, 2018

(54) PARKING FORECAST AND PARKING GUIDANCE PLANNING SYSTEM AND METHOD

(71) Applicant: INSTITUTE FOR INFORMATION INDUSTRY, TAIPEI (TW)

(72) Inventor: Kun-Hung LEE, Taipei City (TW)

(21) Appl. No.: 15/369,904

(22) Filed: Dec. 6, 2016

(30) Foreign Application Priority Data
Nov. 30, 2016 (TW) 105139548

(51) Int. Cl. G06Q 10/02; G08G 1/14

(52) U.S. Cl. CPC G06Q 10/02; G06Q 2240/00; G08G 1/141

(57) ABSTRACT

The present disclosure provides parking forecast and parking guidance planning system and method. This method includes steps as follow. A parking request is received from a user device. The arrival times and estimated waiting times for the multiple parking lots at the destination are estimated according to the parking request. A candidate parking lot with the shortest time is selected from the multiple parking lots, and the user device is guided to the candidate parking lot.

### RELATED APPLICATION LICATIONS

This application claims priority to Taiwan Application Serial Number 105139548, filed Nov. 30, 2016, which is herein incorporated by reference.

### BACKGROUND

### Field of Invention

The present invention relates to forecast and guidance planning systems and methods. More particularly, the present invention relates to parking forecast and parking guidance planning systems and methods.

### Description of Related Art

A driver often inquires information indicates that a parking lot has a vacant parking space, but when his or her car arrives the parking lot, the parking lot is full of cars. The prior art does not consider the change of the vacant parking spaces in the parking lot during the driver's car moves to the parking lot. Moreover, cars queuing up for the parking lot cause estimated waiting time to be error.

In addition, the prior art is incapable of predicting the parking lot situation in advance, and it is inconvenient to plan the route in advance.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

According to embodiments of the present disclosure, the present disclosure provides parking forecast and parking guidance planning systems and methods, to solve or circumvent aforesaid problems and disadvantages.

In one embodiment, a parking forecast and parking guidance planning system comprises: a processor; a storage device electrically connected to the processor, the storage device storing a historical data; and a network device electrically connected to the processor, wherein when the network device receives a parking request from a user device, the parking request comprises a destination, a place of departure and a departure time, the processor performs a parking forecast and parking guidance planning procedure according to the parking request, the parking forecast and parking guidance planning procedure comprising: calculating arrival times that a vehicle arrives a plurality of parking lots respectively in a predetermined nearby area of the destination according to an estimated vehicle speed in a time period during which the vehicle moves from the place of departure at the departure time to the destination; determining whether each of the parking lots has a vacant parking space according to at least one of historical vehicle parking data at the arrival time of each of the parking lots in the historical data, real-time vehicle parking data received through the network from each of the parking lots device, the number of added reservations at the arrival time previously, and the number of current reservations; if at least one of the parking lots has no vacant parking space, calculating a waiting time of the vehicle for the at least one of the parking lots at the arrival time; and selecting a first candidate parking lot that the vehicle needs a shortest time for parking from the parking lots according to the arrival time and the waiting time, and transmitting information on the first candidate parking lot to the user device through the network device, wherein the processor performs a reservation process to make the user device reserve the first candidate parking lot.

In one embodiment, the estimated vehicle speed is a historical average speed.

In one embodiment, the processor performs a guiding process to guide the user device to the first candidate parking lot through the network device.

In one embodiment, if the parking lot has no vacant parking space, the processor calculates the waiting time according to an average vehicle departure time of the parking lot at the arrival time previously in the historical data with the number of vehicles queuing up for the parking lot previously.

In one embodiment, the processor selects a maximum number from the number of vehicles queuing up for the parking lot previously in the historical data, the number of added reservations previously in the historical data, and the number of current reservations, and multiplies the maximum number and the average vehicle departure time to calculate the waiting time.

In one embodiment, if other one or more user devices also reserve the first candidate parking lot before the arrival time of the user device, and if the number of total reservations of the other one or more user devices are more than the maximum number, the processor commands the user device to provides its current location through the network device for performing the parking forecast and parking guidance planning procedure anew to obtain a second candidate parking lot, and when the first candidate parking lot is different from the second candidate parking lot, the processor guides the user device to the second candidate parking lot through the network device.

In one embodiment, if other one or more user devices also reserve the first candidate parking lot, but reservation time of other one or more user devices is later than the arrival time of the user device, the processor guides the user device to the first candidate parking lot through the network device.

In one embodiment, when the parking lot has the vacant parking space, the processor determines that the waiting time is zero.

In one embodiment, during the vehicle with the user device is moving to the first candidate parking lot, the user device transmits its current location to the network device, the processor performs the parking forecast and parking guidance planning procedure anew according to the current location of the user device and a current time, so as to obtain a second candidate parking lot, and when the first candidate parking lot is different from the second candidate parking lot, the processor guides the user device to the second candidate parking lot through the network device.

In one embodiment, a parking forecast and parking guidance planning method, comprising steps of: receiving a parking request from a user device through the network device, the parking request comprising a destination, a place of departure and a departure time, and performing a parking forecast and parking guidance planning procedure according to the parking request, the parking forecast and parking guidance planning procedure comprising: (A) using a processor to calculate arrival times that a vehicle arrives a plurality of parking lots respectively in a predetermined nearby area of the destination according to an estimated vehicle speed in a time period during which the vehicle moves from the place of departure at the departure time to the destination; (B) using the processor to determine whether each of the parking lots has a vacant parking space according to at least one of historical vehicle parking data at the arrival time of each of the parking lots in the historical data, real-time vehicle parking data received through the network from each of the parking lots device, the number of added reservations at the arrival time previously, and the number of current reservations; if at least one of the parking lots has no vacant parking space, the processor calculates a waiting time of the vehicle for the at least one of the parking lots at the arrival time; and (C) using the processor to select a first candidate parking lot that the vehicle needs a shortest time for parking from the parking lots according to the arrival time and the waiting time, transmitting information on the first candidate parking lot to the user device through the network device, and using the processor to perform a reservation process to make the user device reserve the first candidate parking lot.

In one embodiment, the estimated vehicle speed is a historical average speed.

In one embodiment, the step (C) further comprises: using the processor to perform a guiding process to guide the user device to the first candidate parking lot through the network device.

In one embodiment, the step (B) further comprises: if the parking lot has no vacant parking space, the processor calculates the waiting time according to an average vehicle departure time of the parking lot at the arrival time previously in the historical data with the number of vehicles queuing up for the parking lot previously.

In one embodiment, the step (B) further comprises: using the processor to select a maximum number from the number of vehicles queuing up for the parking lot previously in the historical data, the number of added reservations previously in the historical data, and the number of current reservations, and multiplies the maximum number and the average vehicle departure time to calculate the waiting time.

In one embodiment, the parking forecast and parking guidance planning method further comprises: if other one or more user devices also reserve the first candidate parking lot before the arrival time of the user device, and if the number of total reservations of the other one or more user devices are more than the maximum number, using the processor to command the user device to provides its current location through the network device for performing the parking forecast and parking guidance planning procedure anew to obtain a second candidate parking lot, wherein when the first candidate parking lot is different from the second candidate parking lot, the processor guides the user device to the second candidate parking lot through the network device.

In one embodiment, the parking forecast and parking guidance planning method further comprises: if other one or more user devices also reserve the first candidate parking lot, but reservation time of other one or more user devices is later than the arrival time of the user device, using the processor to guide the user device to the first candidate parking lot through the network device.

In one embodiment, the step (B) further comprises: when the parking lot has a vacant parking space, determining that the waiting time is zero.

In one embodiment, the parking forecast and parking guidance planning method further comprises: during the vehicle with the user device is moving to the first candidate parking lot, using the user device transmits its current location to the network device, so that the processor performs the parking forecast and parking guidance planning procedure anew according to the current location of the user device and a current time, so as to obtain a second candidate parking lot, wherein when the first candidate parking lot is different from the second candidate parking lot, the processor guides the user device to the second candidate parking lot through the network device.

In view of the foregoing, the present disclosure considers the time required for arriving at each parking lot in different time periods and the status of each parking lot reserved by other vehicles, so as to forecast and guide a driver to the optimal parking lot. Before the driver arrives the parking lot, the present disclosure provides a dynamic navigation manner that can be adjusted or switched according to the latest reservation status, so as to improve the accuracy of the forecast, thereby saving waiting time.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a block diagram of a parking forecast and parking guidance planning system according to one embodiment of the present disclosure; and

FIG. 2 is a flow chart of a parking forecast and parking guidance planning method according to one embodiment of the present disclosure.

### DETAILED DESCRIPTION

In the following detailed description, for purposes of explanation, numerous specific details are set forth in order to attain a thorough understanding of the disclosed embodiments. In accordance with common practice, like reference numerals and designations in the various drawings are used to indicate like elements/parts. Moreover, well-known elements or method steps are schematically shown or omitted in order to simplify the drawing and to avoid unnecessary limitation to the claimed invention.

In the detailed embodiment and the claims, unless otherwise indicated, the article “a” or “the” refers to one or more than one of the word modified by the article “a” or “the.”

Through the present specification and the annexed claims, the description involving the “electrical connection” refers to the cases where one component is electrically connected to another component indirectly via other component(s), or one component is electrically connected to another component directly without any other component.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

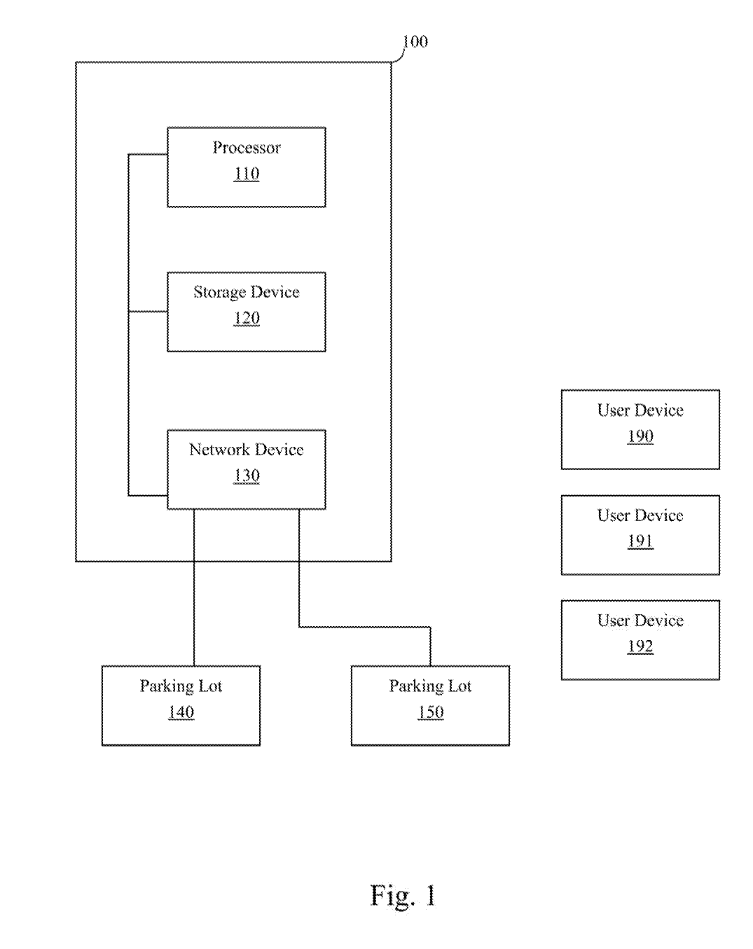

FIG. 1 is a block diagram of a parking forecast and parking guidance planning system 100 according to one embodiment of the present disclosure. As illustrated in FIG. 1, parking forecast and parking guidance planning system 100 comprises a processor 110, a storage device 120 and a network device 130. Structurally, the processor 110 is electrically connected to the storage device 120 and the network device 130, the network device 130 can be communicated with a user device 190, and the network device 130 can be also communicated with a plurality of parking lots 140 and 150 to receive data from the parking lot 140 and 150. For example, the network device 130 receives real-time and historical data from servers of the parking lots 140 and 150.

In practice, the parking forecast and parking guidance planning system 100 can be a server or a computer, in which the processor 110 can be a central processing unit (CPU) or the like, the storage device 120 can be a hard disk or other storage medium, and the network device 130 can be a network card or other wired/wireless transmission hardware device. The user device 190 can be a navigator device, a mobile phone, a tablet or other electronic device.

In use, the storage device 120 stores the historical data (e.g., the historical data of parking lots and traffic). When the network device 130 receives the parking request comprising a destination from the user device 190, the processor 110 performs a parking forecast and parking guidance planning procedure according to the parking request. The parking forecast and parking guidance planning procedure comprises: calculating arrival times that a vehicle arrives a plurality of parking lots 140 and 150 respectively in a predetermined nearby area of the destination according to an estimated vehicle speed; calculating a waiting time of a vehicle for the at least one of the parking lots 140 and 150 at the arrival time; selecting a first candidate parking lot (e.g., the parking lot 150) that the vehicle needs a shortest time for parking from the parking lots 140 and 150 according to the arrival time and the waiting time, and transmitting information on the first candidate parking lot 150 to the user device 190 through the network device 130. In one embodiment, the processor 110 performs a reservation process to make the user device 190 reserve the first candidate parking lot 150 and performs a guiding process to guide the user device 190 to the first candidate parking lot 150 through the network device 130.

It should be noted that a system designer could set the predetermined nearby area. For example, the predetermined nearby area is typically within 0.5 km around the destination, but the present disclosure is not limited to this example.

In practice, a user can previously and currently send the parking request through the user device 190. In one embodiment, the parking request further comprises a place of departure and a departure time, and the processor 110 calculates respective arrival times that the vehicle arrives the parking lots 140 and 150 respectively in a predetermined nearby area of the destination according to the estimated vehicle speed (e.g., a historical average speed in the historical data) in a time period during which the vehicle moves from the place of departure at the departure time to the destination.

As to a more complete description of the parking forecast and parking guidance planning procedure, in one embodiment, the processor 110 determines whether each of the parking lots has a vacant parking space according to at least one of historical vehicle parking data at the arrival time of each of the parking lots in the historical data, real-time vehicle parking data received through the network from each of the parking lots device, the number of added reservations at the arrival time previously, and the number of current reservations.

In one embodiment, if the parking lot has no vacant parking space, the processor 110 calculates the waiting time according to departure time of vehicles (e.g., an average vehicle departure time) of the parking lot at the arrival time previously in the historical data with the number of vehicles queuing up for the parking lot previously.

Moreover, in one specific embodiment, the processor 110 selects a maximum number from the number of vehicles queuing up for the parking lot previously in the historical data, the number of added reservations previously in the historical data, and the number of current reservations, and multiplies the maximum number and the average vehicle departure time to calculate the waiting time.

In one embodiment, if other one or more user devices 191 and 192 also reserve the first candidate parking lot 150 before the arrival time of the user device 190, and if the number of total reservations of the other one or more user devices 191 and 192 are more than the maximum number, it indicates that the number of vehicles exceeds the expected reservation, the processor 110 commands the user device 190 to provides its current location through the network device 130 for performing the parking forecast and parking guidance planning procedure anew to obtain a second candidate parking lot (e.g., the parking lot 140), and when the first candidate parking lot 150 is different from the second candidate parking lot 140, the processor 110 guides the user device 190 to the second candidate parking lot 140 through the network device 130.

In one embodiment, if other one or more user devices 191 and 192 also reserve the first candidate parking lot 150, but reservation time of other one or more user devices 191 and 192 is later than the arrival time of the user device 190, the reservation of the user devices 191 and 192 cannot affect the original guidance for the user devices 191 and 192; therefore, the processor 110 guides the user device 190 to the first candidate parking lot 150 through the network device 130.

Otherwise, in one embodiment, when the parking lot has a vacant parking space, the processor 110 determines that the waiting time is zero. Then, the processor 110 selects the first candidate parking lot 150 that the vehicle needs a shortest time (e.g., the sum of the arrival time and the waiting time) for parking from the parking lots 140 and 150, and reserves the first candidate parking lot 150 for the user device 190.

Moreover, after the parking forecast and parking guidance planning procedure forecasts the first candidate parking lot 150, during the vehicle with the user device 190 is moving to the first candidate parking lot 150, the user device automatically or manually transmits its current location (e.g., a GPS position) to the network device 130, the processor 110 performs the parking forecast and parking guidance planning procedure anew according to the current location of the user device 190 and a current time, so as to obtain a second candidate parking lot 140. When the first candidate parking lot 150 is different from the second candidate parking lot 140, it indicates that the vehicle currently has a shorter time for parking in the second candidate parking lot 140 rather than the first candidate parking lot 150, the processor 110 guides the user device 190 to the second candidate parking lot 140 through the network device 130.

For example, if the user starts to drive the vehicle at 8:00 to the destination, the parking forecast and parking guidance planning system 100 forecasts that the user needs 30 minutes to arrive the parking lot 140 near the destination and needs 40 minutes to arrive the parking lot 150 near the destination according to the historical data. However, the parking forecast and parking guidance planning system 100 checks the parking status and the reservation amount of the parking lot 140 at 8:30 in the past and forecasts that the user may wait 25 minutes for a vacant parking space after the arrival of the parking lot 140. The parking forecast and parking guidance planning system 100 also checks the parking status and the reservation amount of the parking lot 150 at 8:40 in the past and forecasts that the user may wait 10 minutes for a vacant parking space after the arrival of the parking lot 150. Accordingly, the user may need 55 (30+25) minutes for parking in the parking lot 140 or may need 50 (40+10) minutes for parking in the parking lot 150. Thus, the parking forecast and parking guidance planning system 100 sets the parking lot 150 as the first candidate parking lot.

During the user drives the vehicle to the parking lot 150, the parking forecast and parking guidance planning system 100 checks that the first candidate parking lot 150 reserved by other vehicles, and other vehicles' reservation time is earlier than the user's arrival time, and forecasts that the waiting time will be delayed for another 15 minutes. Accordingly, the user may need 55 (30+25) minutes for parking in the parking lot 140 or may need 65 (40+10+15) minutes for parking in the parking lot 150. Thus, the parking forecast and parking guidance planning system 100 guides the user device to the user to the parking lot 140 (i.e., the second candidate parking lot).

Moreover, if the user previously sets the departure time and the destination, the parking forecast and parking guidance planning system 100 also analyzes adjacent time periods before and after the arrival time to calculate respective durations of the route, so as to provide other suggestions for the user (e.g., the driver) to adjust the departure time. For example, the user previously sets that he or she starts to drive the vehicle at 8:00 to the destination, the parking forecast and parking guidance planning system 100 further analyzes an estimated parking status of the parking lot 140 at 8:00 and 9:00 before and after before and after the arrival time (e.g., 8:30) and analyzes an estimated parking status of the parking lot 150 at 8:10 and 9:10 before and after before and after the arrival time (e.g., 8:40).

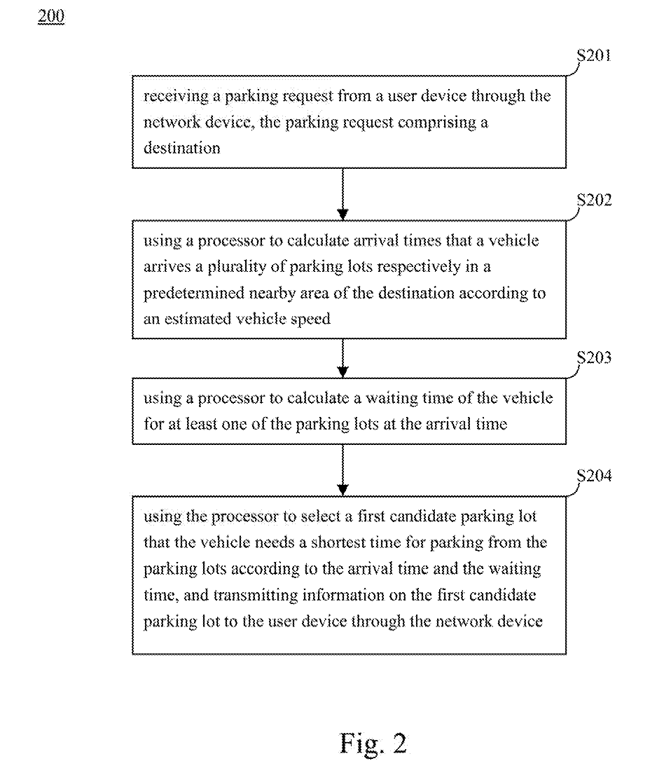

For a more complete understanding of parking forecast and parking guidance planning method performed by the parking forecast and parking guidance planning system 100, refer to FIG. 2. FIG. 2 is a flow chart of the parking forecast and parking guidance planning method 200 according to one embodiment of the present disclosure. As illustrated in FIG. 2, the parking forecast and parking guidance planning method 200 includes the operations S201-S204. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently. The parking forecast and parking guidance planning method 200 can be implemented by a server, such as above parking forecast and parking guidance planning system 100. With reference to FIGS. 1-2, some embodiments are explanted below.

In operation S201, the network device 130 is used to receive the parking request comprising a destination from the user device 190. Then, the processor 110 performs a parking forecast and parking guidance planning procedure in operation S202-S204 according to the parking request, as detailed below.

In operation S202, the processor 110 is used to calculate respective arrival times that the vehicle arrives a plurality of parking lots 140 and 150 respectively in the predetermined nearby area of the destination according to the estimated vehicle speed. Specifically, in one embodiment, the parking request further comprises a place of departure and a departure time, and in operation S202, the processor 110 calculates respective arrival times that the vehicle arrives the parking lots 140 and 150 respectively in a predetermined nearby area of the destination according to the estimated vehicle speed (e.g., a historical average speed in the historical data) in a time period during which the vehicle moves from the place of departure at the departure time to the destination. It should be noted that a system designer could set the predetermined nearby area. For example, the predetermined nearby area is typically within 0.5 km around the destination, but the present disclosure is not limited to this example.

In operation S203, the processor 110 calculates a waiting time of a vehicle for the at least one of the parking lots 140 and 150 at the arrival time. In one embodiment, operation S203 comprises: in one embodiment, using the processor 110 to determine whether each of the parking lots has a vacant parking space according to at least one of historical vehicle parking data at the arrival time of each of the parking lots in the historical data, real-time vehicle parking data received through the network from each of the parking lots device, the number of added reservations at the arrival time previously, and the number of current reservations.

In one embodiment, if the parking lot has no vacant parking space, in operation S203, the processor 110 calculates the waiting time according to departure time of vehicles (e.g., an average vehicle departure time) of the parking lot at the arrival time previously in the historical data with the number of vehicles queuing up for the parking lot previously. Moreover, in operation S203, the processor 110 selects a maximum number from the number of vehicles queuing up for the parking lot previously in the historical data, the number of added reservations previously in the historical data, and the number of current reservations, and multiplies the maximum number and the average vehicle departure time to calculate the waiting time.

Otherwise, in one embodiment, when the parking lot has a vacant parking space, the processor 110 determines that the waiting time is zero in operation S203.

In operation S204, the processor 110 selects a first candidate parking lot (e.g., the parking lot 150) that the vehicle needs a shortest time for parking from the parking lots 140 and 150 according to the arrival time and the waiting time, and transmitting information on the first candidate parking lot 150 to the user device 190 through the network device 130. In one embodiment, operation S204 further comprises: using the processor 110 to perform a reservation process to make the user device 190 reserve the first candidate parking lot 150, and using the processor 110 to perform a guiding process to guide the user device 190 to the first candidate parking lot 150 through the network device 130.

In the parking forecast and parking guidance planning method 200, if other one or more user devices 191 and 192 also reserve the first candidate parking lot 150 before the arrival time of the user device 190, and if the number of total reservations of the other one or more user devices 191 and 192 are more than the maximum number, it indicates that the number of vehicles exceeds the expected reservation, the processor 110 commands the user device 190 to provides its current location through the network device 130 for performing the parking forecast and parking guidance planning procedure anew to obtain a second candidate parking lot (e.g., the parking lot 140), and when the first candidate parking lot 150 is different from the second candidate parking lot 140, the processor 110 guides the user device 190 to the second candidate parking lot 140 through the network device 130.

In the parking forecast and parking guidance planning method 200, if other one or more user devices 191 and 192 also reserve the first candidate parking lot 150, but reservation time of other one or more user devices 191 and 192 is later than the arrival time of the user device 190, the reservation of the user devices 191 and 192 cannot affect the original guidance for the user devices 191 and 192; therefore, the processor 110 guides the user device 190 to the first candidate parking lot 150 through the network device 130.

during the vehicle with the user device 190 is moving to the first candidate parking lot 150, the user device automatically or manually transmits its current location (e.g., a GPS position) to the network device 130, the processor 110 performs the parking forecast and parking guidance planning procedure in operations S202-S204 anew according to the current location of the user device 190 and a current time, so as to obtain a second candidate parking lot 140. When the first candidate parking lot 150 is different from the second candidate parking lot 140, it indicates that the vehicle currently has a shorter time for parking in the second candidate parking lot 140 rather than the first candidate parking lot 150, the processor 110 guides the user device 190 to the second candidate parking lot 140 through the network device 130.

In view of the foregoing, the present disclosure considers the time required for arriving at each parking lot in different time periods and the status of each parking lot reserved by other vehicles, so as to forecast and guide a driver to the optimal parking lot. Before the driver arrives the parking lot, the present disclosure provides a dynamic navigation manner that can be adjusted or switched according to the latest reservation status, so as to improve the accuracy of the forecast, thereby saving waiting time.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. A parking forecast and parking guidance planning system, comprising:
a processor;
a storage device electrically connected to the processor, the storage device storing a historical data; and
a network device electrically connected to the processor, wherein when the network device receives a parking request from a user device, the parking request comprises a destination, a place of departure and a departure time, the processor performs a parking forecast and parking guidance planning procedure according to the parking request, the parking forecast and parking guidance planning procedure comprising:
calculating arrival times that a vehicle arrives a plurality of parking lots respectively in a predetermined nearby area of the destination according to an estimated vehicle speed in a time period during which the vehicle moves from the place of departure at the departure time to the destination;
determining whether each of the parking lots has a vacant parking space according to at least one of historical vehicle parking data at the arrival time of each of the parking lots in the historical data, real-time vehicle parking data received through the network from each of the parking lots device, the number of added reservations at the arrival time previously, and the number of current reservations;
if at least one of the parking lots has no vacant parking space, calculating a waiting time of the vehicle for the at least one of the parking lots at the arrival time; and
selecting a first candidate parking lot that the vehicle needs a shortest time for parking from the parking lots according to the arrival time and the waiting time, and transmitting information on the first candidate parking lot to the user device through the network device, wherein the processor performs a reservation process to make the user device reserve the first candidate parking lot.

2. The parking forecast and parking guidance planning system of claim 1, wherein the estimated vehicle speed is a historical average speed.

3. The parking forecast and parking guidance planning system of claim 1, wherein the processor performs a guiding process to guide the user device to the first candidate parking lot through the network device.

4. The parking forecast and parking guidance planning system of claim 1, wherein if the parking lot has no vacant parking space, the processor calculates the waiting time according to an average vehicle departure time of the parking lot at the arrival time previously in the historical data with the number of vehicles queuing up for the parking lot previously.

5. The parking forecast and parking guidance planning system of claim 4, wherein the processor selects a maximum number from the number of vehicles queuing up for the parking lot previously in the historical data, the number of added reservations previously in the historical data, and the number of current reservations, and multiplies the maximum number and the average vehicle departure time to calculate the waiting time.

6. The parking forecast and parking guidance planning system of claim 5, wherein if other one or more user devices also reserve the first candidate parking lot before the arrival time of the user device, and if the number of total reservations of the other one or more user devices are more than the maximum number, the processor commands the user device to provides its current location through the network device for performing the parking forecast and parking guidance planning procedure anew to obtain a second candidate parking lot, and when the first candidate parking lot is different from the second candidate parking lot, the processor guides the user device to the second candidate parking lot through the network device.

7. The parking forecast and parking guidance planning system of claim 5, wherein if other one or more user devices also reserve the first candidate parking lot, but reservation time of other one or more user devices is later than the arrival time of the user device, the processor guides the user device to the first candidate parking lot through the network device.

8. The parking forecast and parking guidance planning system of claim 1, wherein when the parking lot has the vacant parking space, the processor determines that the waiting time is zero.

9. The parking forecast and parking guidance planning system of claim 1, wherein during the vehicle with the user device is moving to the first candidate parking lot, the user device transmits its current location to the network device, the processor performs the parking forecast and parking guidance planning procedure anew according to the current location of the user device and a current time, so as to obtain a second candidate parking lot, and when the first candidate parking lot is different from the second candidate parking lot, the processor guides the user device to the second candidate parking lot through the network device.

10. A parking forecast and parking guidance planning method, comprising steps of:
receiving a parking request from a user device through the network device, the parking request comprising a destination, a place of departure and a departure time, and performing a parking forecast and parking guidance planning procedure according to the parking request, the parking forecast and parking guidance planning procedure comprising:
(A) using a processor to calculate arrival times that a vehicle arrives a plurality of parking lots respectively in a predetermined nearby area of the destination according to an estimated vehicle speed in a time period during which the vehicle moves from the place of departure at the departure time to the destination;
(B) using the processor to determine whether each of the parking lots has a vacant parking space according to at least one of historical vehicle parking data at the arrival time of each of the parking lots in the historical data, real-time vehicle parking data received through the network from each of the parking lots device, the number of added reservations at the arrival time previously, and the number of current reservations; if at least one of the parking lots has no vacant parking space, the processor calculates a waiting time of the vehicle for the at least one of the parking lots at the arrival time; and
(C) using the processor to select a first candidate parking lot that the vehicle needs a shortest time for parking from the parking lots according to the arrival time and the waiting time, transmitting information on the first candidate parking lot to the user device through the network device, and using the processor to perform a reservation process to make the user device reserve the first candidate parking lot.

11. The parking forecast and parking guidance planning method of claim 10, wherein the estimated vehicle speed is a historical average speed.

12. The parking forecast and parking guidance planning method of claim 10, wherein the step (C) further comprises:
using the processor to perform a guiding process to guide the user device to the first candidate parking lot through the network device.

13. The parking forecast and parking guidance planning method of claim 10, wherein the step (B) further comprises:
if the parking lot has no vacant parking space, the processor calculates the waiting time according to an average vehicle departure time of the parking lot at the arrival time previously in the historical data with the number of vehicles queuing up for the parking lot previously.

14. The parking forecast and parking guidance planning method of claim 13, wherein the step (B) further comprises:
using the processor to select a maximum number from the number of vehicles queuing up for the parking lot previously in the historical data, the number of added reservations previously in the historical data, and the number of current reservations, and multiplies the maximum number and the average vehicle departure time to calculate the waiting time.

15. The parking forecast and parking guidance planning method of claim 14, further comprising:
if other one or more user devices also reserve the first candidate parking lot before the arrival time of the user device, and if the number of total reservations of the other one or more user devices are more than the maximum number, using the processor to command the user device to provides its current location through the network device for performing the parking forecast and parking guidance planning procedure anew to obtain a second candidate parking lot, wherein when the first candidate parking lot is different from the second candidate parking lot, the processor guides the user device to the second candidate parking lot through the network device.

16. The parking forecast and parking guidance planning method of claim 14, further comprising:
if other one or more user devices also reserve the first candidate parking lot, but reservation time of other one or more user devices is later than the arrival time of the user device, using the processor to guide the user device to the first candidate parking lot through the network device.

17. The parking forecast and parking guidance planning method of claim 10, wherein the step (B) further comprises:
when the parking lot has a vacant parking space, determining that the waiting time is zero.

18. The parking forecast and parking guidance planning method of claim 10, further comprising:
during the vehicle with the user device is moving to the first candidate parking lot, using the user device transmits its current location to the network device, so that the processor performs the parking forecast and parking guidance planning procedure anew according to the current location of the user device and a current time, so as to obtain a second candidate parking lot, wherein when the first candidate parking lot is different from the second candidate parking lot, the processor guides the user device to the second candidate parking lot through the network device.
